(19) United States
(12) Patent Application Publication
(10) Pub. No.: US 2026/0320974 A1
(43) Pub. Date: Oct. 15, 2026

(54) IDENTITY REPRESENTATION FOR GENERATIVE TASKS

(71) Applicant: Snap Inc., Santa Monica, CA (US)

(72) Inventors: Guocheng Qian, Mountain View, CA (US); Kuan-Chieh Wang, Sunnyvale, CA (US); Or Patashnik, Tel Aviv (IL); Negin Heravi, Palo Alto, CA (US); Daniil Ostashev, London (GB); Sergey Tulyakov, Santa Monica, CA (US); Daniel Cohen-Or, Tel Aviv (IL); Kfir Aberman, Redwood City, CA (US)

(21) Appl. No.: 19/174,279

(22) Filed: Apr. 9, 2025

(51) Int. Cl. G06V 10/77; G06V 10/40; G06V 10/774; G06V 10/82; G06V 20/40; G06V 40/10

(52) U.S. Cl. CPC G06V 10/7715; G06V 10/40; G06V 10/774; G06V 10/82; G06V 20/46; G06V 40/10

(57) ABSTRACT

The present disclosure seeks to address technical problems arising in the field of artificial intelligence (AI) by providing for a multiple-input, fixed-size representation that is used for generative tasks, such as image generation. The representation combines identity preserving features for a subject from the multiple inputs to facilitate generation of high quality images of the subject in a variety of poses, states, conditions, and environments. To generate the representation, an encoder is trained using a multi-decoder training strategy to facilitate the generation of a representation that can be used by various decoders with various objectives.

### TECHNICAL FIELD

The present disclosure relates to digital imaging systems. In particular, the present disclosure relates to camera systems and image processing hardware for capturing and generating identity-preserving representations.

### BACKGROUND

In the field of artificial intelligence (AI), various machine learning technologies have been developed to perform functions of varying complexity, such as classification, computer vision, and natural language processing. As machine learning models continue to grow in complexity and sophistication, they are being applied to increasingly diverse applications across numerous technical fields. The implementation of these complex machine learning models presents various technical challenges related to computational efficiency, resource utilization, and output quality that continue to be addressed through ongoing research and development in the field.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a machine learning pipeline, according to some examples.

FIG. 4 is a diagrammatic representation of training and use of a machine learning program, according to some examples.

FIG. 5 is a diagrammatic representation of generating identity representations using a machine learning model, according to some examples.

FIG. 6 is a diagrammatic representation of generating identity representations using a machine learning model, according to some examples.

FIG. 7 is a diagrammatic representation of learnable queries used in generating identity representations, according to some examples.

FIG. 8 is a diagrammatic representation of generating images using identity representations, according to some examples.

FIG. 9 is a diagrammatic representation of a method, according to some examples.

FIG. 10 is a diagrammatic representation of a data structure as maintained in a database, according to some examples.

FIG. 11 is a diagrammatic representation of a message, according to some examples.

FIG. 12 is a diagrammatic representation of a machine in the form of a computer system within which a set of instructions may be executed to cause the machine to perform any one or more of the methodologies discussed herein, according to some examples.

FIG. 13 is a block diagram showing a software architecture within which examples may be implemented.

### DETAILED DESCRIPTION

As machine learning models are tasked with performing increasingly complex functions, these machine learning models face both new technical challenges and existing technical challenges that impede the performance of these increasingly complex functions. For example, some machine learning models are tasked with complex functions such as generating a new image of a person based on an existing image of the person. The new image may be generated, for example, to depict the person in a particular style or performing a particular action based on an input prompt. In many cases, the machine learning models tasked with such complex functions fail to preserve identity features of the person such that the new image of the person does not accurately resemble the person in the existing image. In other cases, the machine learning models tasked with such complex functions overly fits the new image to the existing image such that the person in the new image looks unnatural relative to the rest of the new image, as if copy-pasted from the existing image. These technical challenges are further exacerbated by growing expectations for high quality images that accurately preserve identity features. Thus, machine learning models face technical problems with respect to preservation of identity features.

The present disclosure seeks to address these and other technical problems arising in the field of artificial intelligence (AI). As an overview of some examples, the present disclosure provides for a multiple-input, fixed-size representation that is used for generative tasks, such as image generation. For example, multiple images of an object, such as a face, are encoded into a single, fixed-size representation (e.g., vector representation). The representation maintains a consistent size (e.g., 256 tokens) regardless of the number of images of the object that are encoded into the representation, providing a standardized format for downstream applications, such as image generation. To maintain a consistent size, the representation combines visual information from multiple input images into structured entries corresponding with particular features, such as facial features (e.g., eye color, facial hair), or particular regions, such as facial regions (e.g., eyes, mouth, ears). In some examples, each entry corresponds with a learnable query that captures semantic information corresponding with the particular feature or the particular region of the entry. Through the features of the multiple-input, fixed-size representation described herein, detailed information, such as identity information, used to preserve high fidelity and fine detail in generative tasks are holistically captured from a range of different inputs. This facilitates improvements in accuracy compared to generative tasks that are based on, for example, a single input, such as a single image.

In some examples, an encoder is trained to generate a representation used for generative tasks. For example, the encoder is trained to extract image features from a set of images. The image features are combined using learnable queries that function as semantic-aware tokens corresponding with particular features or particular regions to be described by the representation. In some examples, the encoder includes a transformer-based architecture with cross-attention layers and self-attention layers through which the combined image features are passed as key components and value components with the learnable queries passed as query components. By processing the combined image features with the learnable queries through the cross-attention layers and the self-attention layers, a fixed-size representation including the identity features extracted from the set of images is generated.

In some examples, training the encoder involves a few-to-many reconstruction objective using multiple decoders. For example, the encoder is trained using training data that includes a set of images. A subset of the set of images are provided to the encoder, and the encoder generates a representation based on the subset of images. The representation is provided to the multiple decoders, and the multiple decoders generate images based on the representation. The encoder is trained to minimize a loss function between the images generated by the multiple decoders and the set of images.

In some examples, the trained encoder is used to generate a representation that is used in downstream generative tasks, such as image generation. For example, a set of images of a subject (e.g., person, face, object) are obtained by sampling a video capturing the subject from various angles. A recognition algorithm (e.g., facial recognition, object recognition) is applied to the set of images to identify the subject in the set of images. The set of images are clustered based on poses of the subject in the set of images. For each cluster of images, an image is selected based on image quality estimations (e.g., TOPIQ, HyperIQA, NIQE). The images selected from the clusters of images are encoded by the trained encoder to generate a representation of the subject.

Through the generation and use of the multiple-input, fixed-size representation described herein, generative tasks are improved with respect to accuracy and identity preservation. For example, by using multiple inputs for the representation, the representation includes features of the subject that blend information from multiple sources, providing a more semantically accurate description of the features. This facilitates generation of images with higher fidelity and identity preservation compared to, for example, images generated based on a single input image. Furthermore, overfitting that typically occurs with images generated based on a single input image is prevented by incorporating information from multiple inputs and by optimization to reconstruct more new images in the training. Moreover, the generation and use of the multiple-input, fixed-size representation described herein facilitates generative tasks by providing a structured representation that supports generative objectives as opposed to, for example, discriminative or contrastive objectives. Therefore, generative tasks, such as image generation, using the representations described herein more consistently produce high-fidelity, feature-preserving outputs. Further details related to these technical solutions are provided herein.

### Networked Computing Environment

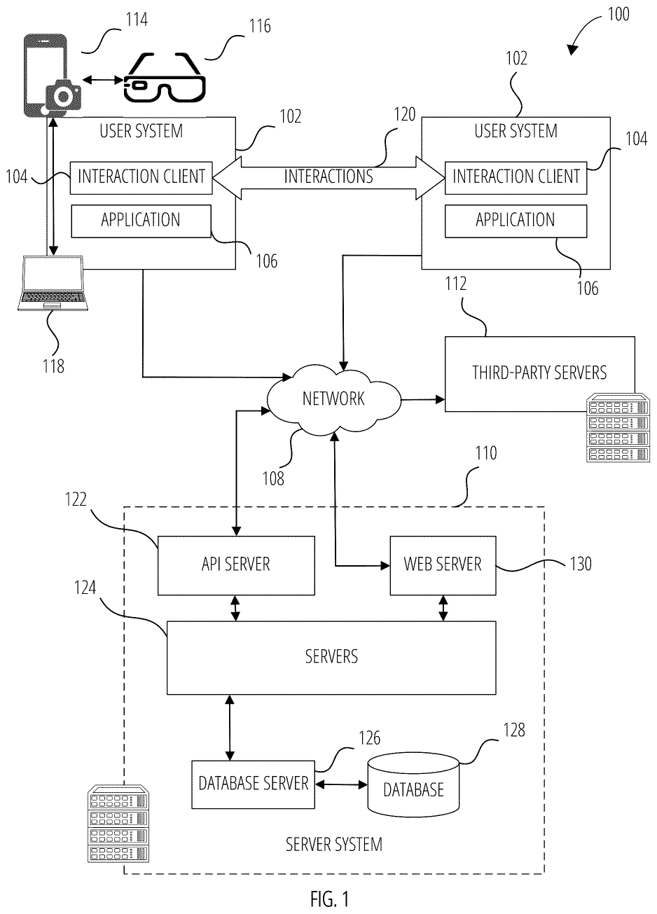

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 1008); the location of friends within an entity relationship graph; and opening an application event (e.g., relating to the interaction client 104).

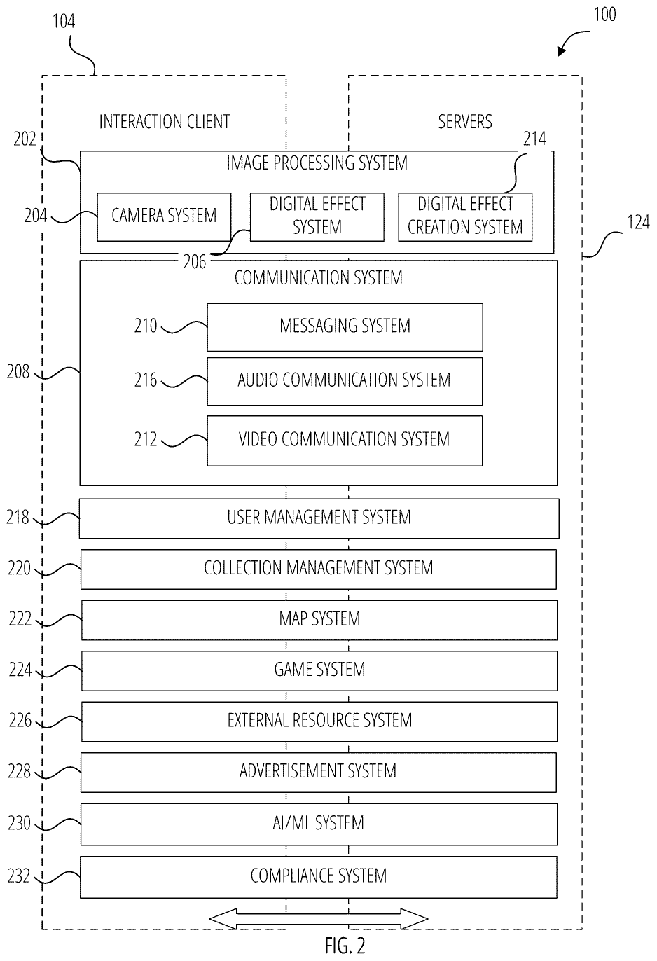

The servers 124 host multiple systems and subsystems, described below with reference to FIG. 2.

### External Recources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls hardware camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory of a user system 102. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 1006, entity graphs 1008 and profile data 1002) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 1002) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Machine Learning Pipeline

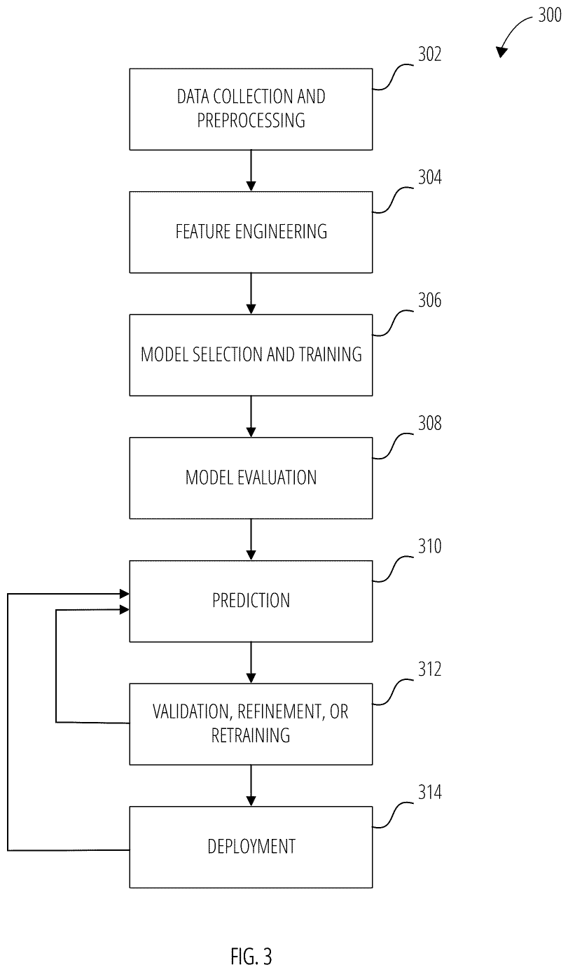

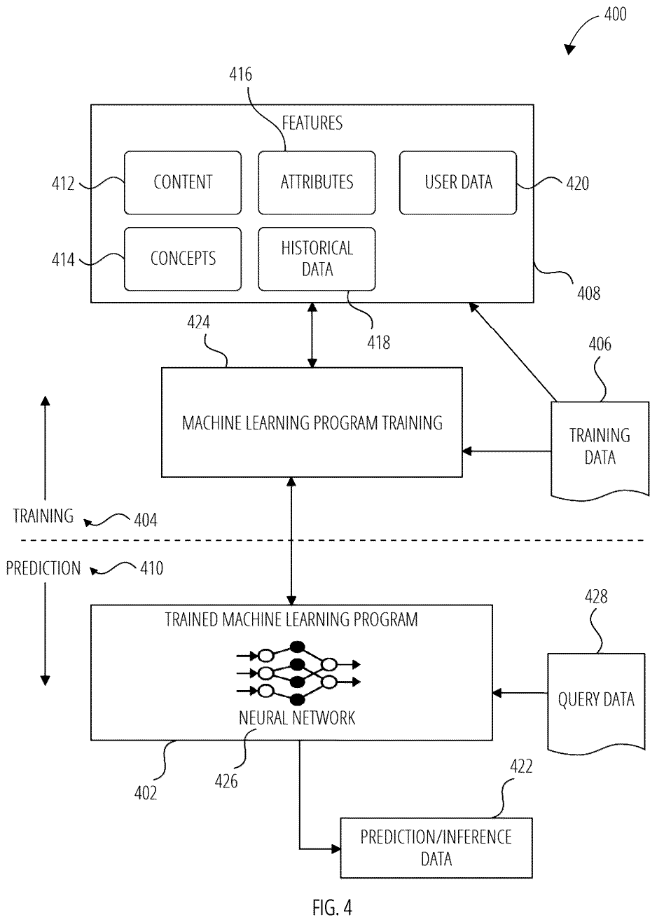

FIG. 3 is a flowchart 300 illustrating a machine learning pipeline, according to some examples. The machine learning pipeline may be used to generate a trained model such as, for example, the trained machine learning program 402 shown in the block diagram 400 of FIG. 4.

Broadly, machine learning may involve using computer algorithms to automatically learn patterns and relationships in data, potentially without the need for explicit programming. Machine learning algorithms may be divided into three main categories: supervised learning, unsupervised learning, and reinforcement learning.
Supervised learning involves training a model using labeled data to predict an output for new, unseen inputs. Examples of supervised learning algorithms may include linear regression, decision trees, and neural networks.
Unsupervised learning involves training a model on unlabeled data to find hidden patterns and relationships in the data. Examples of unsupervised learning algorithms may include clustering, principal component analysis, and generative models, such as autoencoders.
Reinforcement learning involves training a model to make decisions in a dynamic environment by receiving feedback in the form of rewards or penalties. Examples of reinforcement learning algorithms may include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is a supervised learning algorithm used for classification tasks. Naïve Bayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms may include decision trees, k-nearest neighbors, clustering algorithms, and deep learning algorithms, such as Convolutional Neural Networks (CNNs), Recurrent Neural Networks (RNNs), and transformer models. The choice of algorithm may depend on the nature of the data, the complexity of the problem, and the performance requirements of the application.

The performance of machine learning models may be evaluated on a separate test set of data that was not used during training to ensure that the model can generalize to new, unseen data. Although several specific examples of machine learning algorithms are discussed herein, the principles discussed herein can, where possible or relevant, be applied to other machine learning algorithms as well. Deep learning algorithms such as CNNs, RNNs, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine learning program 402 may include multiple phases that form part of the machine learning pipeline, including, for example, the following phases illustrated in FIG. 3:
Data collection and preprocessing 302: This phase may include acquiring and cleaning data to ensure that it is suitable for use in the machine learning model. This phase may also include removing duplicates, handling missing values, and converting data into a suitable format.
Feature engineering 304: This phase may include selecting and transforming the training data 406 to create features that are useful for predicting the target variable. Feature engineering may include (1) receiving features 408 (e.g., as structured or labeled data in supervised learning) and/or (2) identifying features 408 (e.g., unstructured, or unlabeled data for unsupervised learning) in training data 406.
Model selection and training 306: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 308: This phase may include evaluating the performance of a trained model (e.g., the trained machine learning program 402) on a separate testing dataset. This phase can help determine if the model is overfitting or underfitting and determine whether the model is suitable for deployment.
Prediction 310: This phase involves using a trained model (e.g., trained machine learning program 402) to generate predictions on new, unseen data.
Validation, refinement, or retraining 312: This phase may include updating a model based on feedback generated from the prediction phase, such as new data or user feedback.
Deployment 314: This phase may include integrating the trained model (e.g., the trained machine learning program 402) into a more extensive system or application, such as a web service, mobile app, or Internet of Things (IoT) device. This phase can involve setting up APIs, building a user interface, and ensuring that the model is scalable and can handle large volumes of data.

FIG. 4 is a block diagram 400 illustrating further details of two example phases, namely a training phase 404 (e.g., part of model selection and training 306) and a prediction phase 410 (part of prediction 310). Prior to the training phase 404, feature engineering 304 is used to identify features 408. This may include identifying informative, discriminating, and independent features for effectively operating the trained machine learning program 402 in pattern recognition, classification, and regression. In some examples, the training data 406 includes labeled data, known for pre-identified features 408 and one or more outcomes. Each of the features 408 may be a variable or attribute, such as an individual measurable property of a process, article, system, or phenomenon represented by a data set (e.g., the training data 406). Features 408 may also be of different types, such as numeric features, strings, and graphs, and may include one or more of content 412, concepts 414, attributes 416, historical data 418, and/or user data 420, merely for example.

In training phase 404, the machine learning program may use the training data 406 to find correlations among the features 408 that affect a predicted outcome or prediction/inference data 422. With the training data 406 and the identified features 408, the trained machine learning program 402 is trained during the training phase 404 during machine learning program training 424. The machine learning program training 424 appraises values of the features 408 as they correlate to the training data 406. The result of the training is the trained machine learning program 402 (e.g., a trained or learned model).

Further, the training phase 404 may involve machine learning, in which the training data 406 is structured (e.g., labeled during preprocessing operations). The trained machine learning program 402 may implement a neural network 426 capable of performing, for example, classification or clustering operations. In other examples, the training phase 404 may involve deep learning, in which the training data 406 is unstructured, and the trained machine learning program 402 implements a neural network 426 that can perform both feature extraction and classification/clustering operations.

In some examples, a neural network 426 may be generated during the training phase 404 and implemented within the trained machine learning program 402. The neural network 426 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 426 may operationally compute a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 426 may also be one of several different types of neural networks, such as a single-layer feed-forward network, a Multilayer Perceptron (MLP), an Artificial Neural Network (ANN), a RNN, a Long Short-Term Memory Network (LSTM), a Bidirectional Neural Network, a symmetrically connected neural network, a Deep Belief Network (DBN), a CNN, a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 404, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In the prediction phase 410, the trained machine learning program 402 uses the features 408 for analyzing query data 428 to generate inferences, outcomes, or predictions, as examples of a prediction/inference data 422. For example, during prediction phase 410, the trained machine learning program 402 generates an output. Query data 428 is provided as an input to the trained machine learning program 402, and the trained machine learning program 402 generates the prediction/inference data 422 as output, responsive to receipt of the query data 428.

In some examples, the trained machine learning program 402 may be a generative AI model. Generative AI is a term that may refer to any type of AI that can create new content. For example, generative AI can produce text, images, video, audio, code, or synthetic data. In some examples, the generated content may be similar to the original data, but not identical.

Some of the techniques that may be used in generative AI are:
CNNs: CNNs may be used for image recognition and computer vision tasks. CNNs may, for example, be designed to extract features from images by using filters or kernels that scan the input image and highlight important patterns.
RNNs: RNNs may be used for processing sequential data, such as speech, text, and time series data, for example. RNNs employ feedback loops that allow them to capture temporal dependencies and remember past inputs.
GANs: GANs may include two neural networks: a generator and a discriminator. The generator network attempts to create realistic content that can “fool” the discriminator network, while the discriminator network attempts to distinguish between real and fake content. The generator and discriminator networks compete with each other and improve over time.
VAEs: VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.
Diffusion models, as described below.

In generative AI examples, the prediction/inference data 422 may include predictions, translations, summaries, answers, media content, or combinations thereof.

A diffusion model is a type of generative machine learning model that can be used to generate images or videos from a given input (e.g., text prompt, input image). It is based on the concept of “diffusing” noise throughout an image to transform it gradually into a new image. A diffusion model may use a sequence of invertible transformations to transform a random noise image into a final image. During training, a diffusion model may learn sequences of transformations that can best transform random noise into desired output. A diffusion model can be fed with input data (e.g., a text describing the desired images and the corresponding output images, an input image and corresponding output videos), and the parameters of the model are adjusted iteratively to improve its ability to generate accurate or good quality images.

Once trained, in order to generate an image, the diffusion model applies a trained sequence of transformations to an input to generate an output image. The model generates the image in a step-by-step manner, updating the image sequentially with additional information until the image is fully generated. In some examples, this process may be repeated to produce a set of candidate images, from which the final image is chosen based on criteria such as a likelihood score. The resulting image may be intended to represent a visual interpretation of a text prompt.

### Image Generation Using Machine Learning

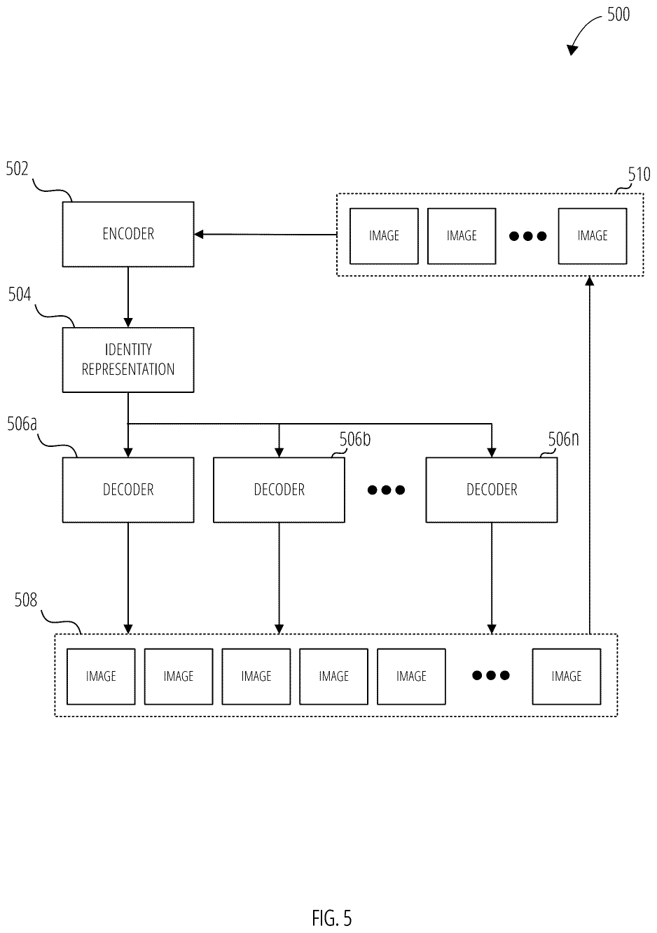

FIG. 5 is a block diagram 500 illustrating a machine learning pipeline for training an encoder 502 to generate identity representations, according to some examples. As illustrated in the block diagram 500, a subset of images 510 is selected from a set of images 508. For example, the set of images 508 is a set of facial images of a person. The subset of images 510 is a subset of the set of facial images of the person. The subset of images 510 is provided to the encoder 502. The encoder 502 generates an identity representation 504 based on the subset of images 510. For example, the identity representation 504 is a fixed-size vector representation of identity features extracted from the subset of images 510. The identity representation 504 is provided to decoders 506a, 506b, . . . 506n. Each decoder generates a set of images. For example, decoder 506a generates a first set of images. Decoder 506b generates a second set of images. Decoder 506n generates an nth set of images. Each set of images generated by the decoders 506a, 506b, . . . 506n are compared with the set of images 508. The encoder 502 is trained to minimize a loss function between the sets of images generated by the decoders 506a, 506b, . . . 506n and the set of images 508. In some examples, the subset of images 510 is a first subset of the set of images 508, and a second subset of images is selected from the set of images 508 as target images. The sets of images generated by the decoders 506a, 506b, . . . 506n are compared with the target images, and the encoder 502 is trained to minimize a loss function between the sets of images generated by the decoders 506a, 506b, . . . 506n and the target images.

As illustrated in the block diagram 500, the encoder 502 is trained using a few-to-many approach in which a smaller set of input images (e.g., the subset of images 510) is used to reconstruct a larger set of target images (e.g., set of images 508). This few-to-many approach in training the encoder 502 causes the encoder 502 to generate the identity representation 504 such that it supports generation of target images with details that may be missing from the input images. Furthermore, the encoder 502 is trained using a multi-decoder training strategy that leverages the complementary strengths of different decoders while mitigating the limitations of any single decoder. Therefore, the encoder 502 is trained to generate the identity representation 504 to support a variety of generative tasks.

In some examples, the decoders 506a, 506b, . . . 506n are tasked with conditionally reconstructing target images based on corrupted target images and the identity representation 504. For example, a corruption process (e.g., masking process, noising process) is applied to a target image to generate a corrupted target image. The decoders 506a, 506b, . . . 506n are tasked with reconstructing the target image based on the corrupted target image. The decoders reconstruct the target image using information from the identity representation 504 to generate the features of the target image that were corrupted in the corruption process. In training the encoder 502 to minimize a loss function between the images generated by the decoders 506a, 506b, . . . 506n and the target images, the encoder 502 is trained to include information in the identity representation 504 that allows the decoders 506a, 506b, 506n to reconstruct corrupted or missing features. Thus, the encoder 502 is trained to generate identity representations that facilitate generative tasks, such as image generation, by providing information that facilitates reconstructing or generating identity preserving features that may be missing from an input.

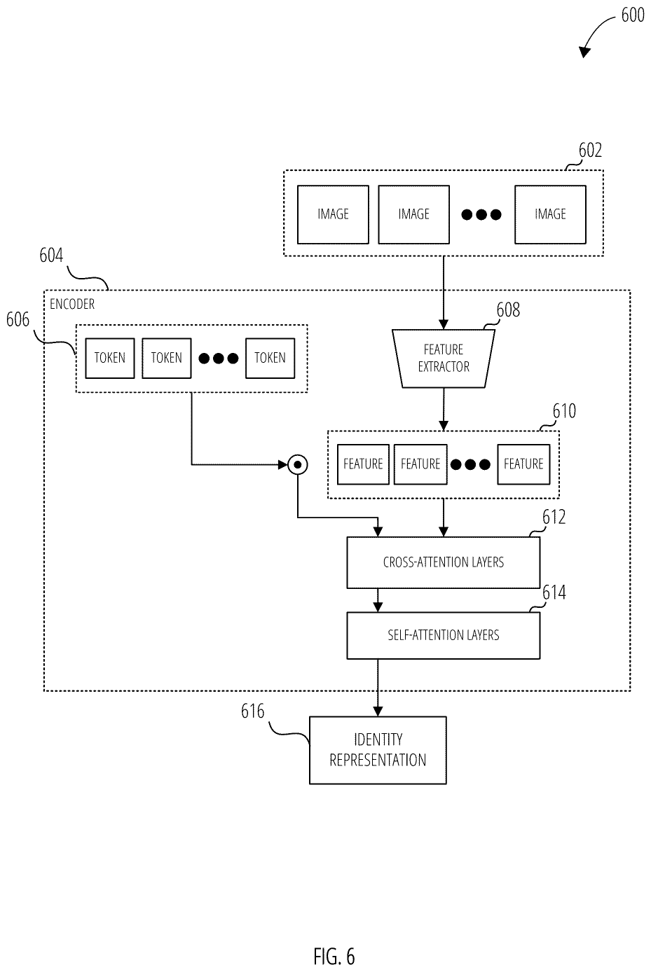

FIG. 6 is a block diagram 600 illustrating architectural features of an encoder 604, according to some examples. In some examples, the encoder 604 has the same architectural features as the encoder 502 of FIG. 5. As illustrated in the block diagram 600, the encoder 604 includes a feature extractor 608 that process a set of images 602 to extract visual features from each image of the set of images 602. In some examples, the feature extractor 608 uses a pretrained contrastive language-image model (e.g., CLIP, CLIP-H) to analyze and interpret each image and relate the visual features (e.g., eyes, mouth, nose, ears) extracted from the images with each other. The visual features extracted from the set of images 602 are combined into a set of features 610. The set of features 610 includes the shared features and identity preserving features extracted from the set of images 602. In some examples, each feature in the set of features 610 corresponds with a particular feature or region of a subject.

As illustrated in the block diagram 600, the encoder 604 includes a set of tokens 606. The set of tokens 606 include learnable queries that are trained to capture identity preserving features from the set of features 610. In training the encoder 604, the learnable queries are trained through trainable parameters to identify and capture identity preserving features in the set of images 602. Through these learnable queries, the set of tokens 606 are trained to become semantic-aware tokens that correspond with the identity preserving features. The set of tokens 606 are combined with the set of features 610 to generate a set of query components, key components, and value components, with the set of tokens 606 providing the query components, and the set of features 610 providing the key components and the value components. The set of query components, key components, and value components are processed through cross-attention layers 612 and self-attention layers 614 of the encoder 604. The cross-attention layers 612 enable the learnable queries of the set of tokens 606 attend to information in the set of features 610 from across all input images in the set of images 602. Each learnable query attends to a specific semantic feature (e.g., eye color, hair color) or semantic region (e.g., eyes, mouth, nose). This creates a structured representation where each token corresponds to a particular feature attribute. The self-attention layers 614 refines the structured representation by consolidating information across the set of features to determine the values for each token and each particular feature attribute. Through processing by the cross-attention layers 612 and the self-attention layers 614, the encoder 604 produces an identity representation 616 based on the set of images 602. The identity representation 616 is a fixed-size vector encoding of the visual features of a subject depicted in the set of images 602. For example, the identity representation 616 comprises 256 tokens with 1280 dimensions per token, with each token corresponding with a semantic feature of the subject depicted in the set of images 602.

As illustrated in the block diagram 600, the encoder 604 generates a fixed-size identity representation 616 regardless of the number of images in the set of images 602. The encoder 604 consolidates the features extracted from the images of the set of images 602 and consolidates the features so that the identity representation 616 maintains a fixed size. This allows the identity representation 616 to become more refined as the number of images in the set of images 602 increases while maintaining a structure that is useable for downstream applications.

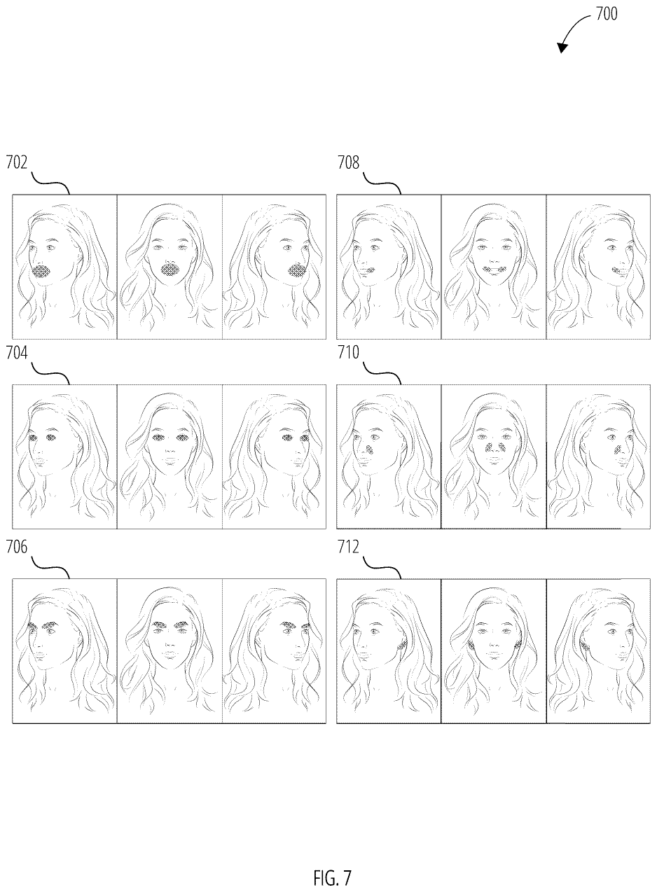

FIG. 7 is a block diagram 700 illustrating semantic regions corresponding with learnable queries, according to some examples. As illustrated in the block diagram 700, each learnable query corresponds with a particular semantic feature or a particular semantic region in a set of images. For example, a first learnable query 702 corresponds with a mouth region in the set of images. As the set of images depicts a subject in different poses, the first learnable query 702 is used to consolidate information related to the mouth region from different angles. A second learnable query 704 corresponds with an eye region in the set of images. Like the first learnable query 702, the second learnable query 704 is used to consolidate information related to the eye region from different angles. A third learnable query 706 corresponds with eyebrow regions in the set of images. The third learnable query 706 is used to consolidate information related to the eyebrow regions from different angles. A fourth learnable query 708 corresponds with mouth corner regions in the set of images. The fourth learnable query 708 is used to consolidate information related to the mouth corner regions from different angles. Furthermore, as illustrated in the block diagram 700, the fourth learnable query 708 consolidates information from images that only depict a left mouth corner, information from images that only depict a right mouth corner, and information from images that depict both mouth corners. Similarly, a fifth learnable query 710 corresponds with cheek regions next to the nose. As some images only depict the left cheek region, some images only depict the right cheek region, and some images depict both cheek regions, the fifth learnable query 710 is used to consolidate information from all of these images with respect to the cheek regions next to the nose. A sixth learnable query 712 corresponds with ears in the set of images. The sixth learnable query 712 is used to consolidate information related to the ears from different angles as well as information from images that only depict the left ear, images that only depict the right ear, and images that depict both ears.

As illustrated in the block diagram 700, the learnable queries 702, 704, 706, 708, 710, 712 effectively consolidate variations in features extracted from a set of images. Therefore, information for a feature, such as a mouth region, includes information consolidated from images of the mouth region from different angles and in different poses. In some examples, information for the feature includes information consolidated from images of the feature in different shapes, different colors, and different conditions. Furthermore, the learnable queries 702, 704, 706, 708, 710, 712 adapt to missing or occluded features in the set of images. For example, information for a feature that is missing or occluded in one image is consolidated with information for the feature that is depicted in another image to provide information that effectively describes the feature. Thus, through application of the learnable queries 702, 704, 706, 708, 710, 712 to a set of images depicting a subject in different poses, the learnable queries 702, 704, 706, 708, 710, 712 account for variations in features as well as instances where the features are missing or occluded to provide a more comprehensive representation of the subject.

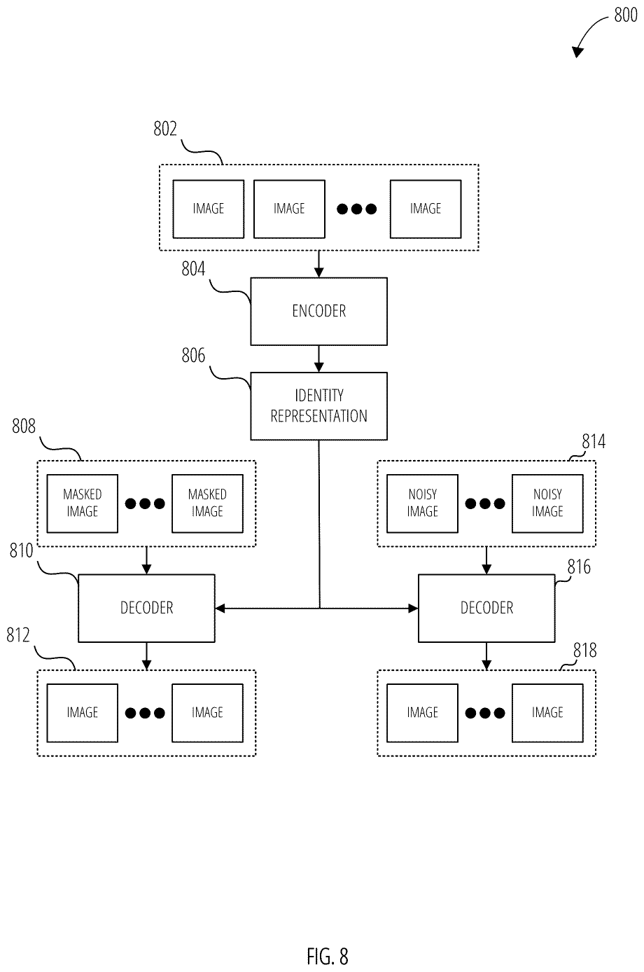

FIG. 8 is a block diagram 800 illustrating a machine learning pipeline for training an encoder 804 to generate identity representations using a first decoder 810 and a second decoder 816, according to some examples. In some examples, the encoder 804 is the encoder 502 of FIG. 5.

As illustrated in the block diagram 800, the encoder 804 receives a set of images 802 and generates an identity representation 806 based on the set of images 802. The first decoder 810 uses the identity representation 806 to generate a first set of images 812 from a set of masked images 808. For example, the set of masked images 808 includes a set of ground truth images (e.g., target images, captured images) that are heavily masked (e.g., 95% masked). The first decoder 810 is, for example, a masked transformer decoder that is tasked with reconstructing the set of ground truth images from the set of masked images 808. Since the set of masked images 808 are heavily masked, the first set of images 812 generated by the first decoder 810 is generated primarily based on information provided by the identity representation 806. The unmasked portions of the set of masked images 808 are sufficient to provide context (e.g., pose, lighting) so that the first decoder 810 generates the first set of images 812 to accurately reconstruct the set of masked images 808 within the correct context.

The encoder 804 is trained, with respect to the first decoder 810, to generate the identity representation 806 so as to minimize a loss function between the first set of images 812 and the set of ground truth images from which the set of masked images 808 are generated. For example, the loss function is:

$${ℒ}_{1} = \frac{1}{\vert {χ}^{r} \vert} {\sum }_{{x}^{r} \sim {χ}^{r}} {\vert ( D ( ℓ , {\tilde{x}}^{r} ) - {x}^{r} ) ⊙ {M}^{r} \vert}_{1}$$

where L₁ is a loss function, X^{r} is a set of ground truth images, D(1, \ddot{x}^{r}) is an output from the first decoder 810 based on a masked image \ddot{x}^{r} and an identity representation 1, x^{r} is a ground truth image, and M^{r} is an input mask (e.g., background mask). Here, the loss function is an average of the differences between the first set of images 812 generated by the first decoder and the ground truth images from which the set of masked images 808 are generated. The input mask masks differences outside a subject area (e.g., face) in the first set of images 812 and the ground truth images so that only the differences in the features depicted in the subject area are evaluated for the loss function.

As illustrated in the block diagram 800, the second decoder 816 uses the identity representation 806 to generate a second set of images 818 from a set of noisy images 814. For example, the set of noisy images 814 are generated from a set of ground truth images (e.g., target images, captured images) that have various levels of noise applied. The second decoder 816 is, for example, a diffusion decoder that is tasked with generating the set of ground truth images from the set of noisy images 814. As the application of various levels of noise in generating the set of noisy images 814 generally removes fine-grained details, the second decoder 816 uses the identity representation 806 to generate the fine-grained details in the second set of images 818.

The encoder 804 is trained, with respect to the second decoder 816, to generate the identity representation 806 so as to minimize a loss function between the second set of images 818 and the set of ground truth images from which the set of noisy images 814 are generated. For example, the loss function is:

$${ℒ}_{2} = {𝔼}_{{x}^{r} \sim {χ}^{r} , t , ϵ} [ {‖ V ( {\tilde{x}}_{t , ϵ}^{r} , t , y , ℓ ) - ( ϵ - {x}^{r} ) ‖}_{2}^{2} ]$$

where L₂ is a loss function, V(\hat{x}^{r}_{t,ϵ}, t, y, l) is an output from the second decoder 816 for a noisy image \ddot{x}^{r}_{t,ϵ} the with a timestep t, a fixed prompt y, and an identity representation l, ϵ is noise, x^{r} is a ground truth image, and E is an expectation (e.g., average) of the L₂ distances between the ground truth images and the images generated by the second decoder 816. The fixed prompt provides a text-based objective (e.g., “photo of a person”) that the second decoder 816 uses to generate the second set of images 818.

Through training the encoder 804 with a multi-decoder training strategy, the encoder 804 is trained with complementary objectives that allows the identity representation 806 to be more robustly applied in various generative tasks. For example, training the encoder 804 with respect to the first decoder 810 trains the encoder 804 to generate the identity representation 806 to support accurate generation of identity preserving features where no information is provided for the features by an input. Training the encoder 804 with respect to the second decoder 816 trains the encoder 804 to generate the identity representation 806 to support generation of fine-grained details of identity preserving features. Therefore, the encoder 804 is trained to generate representations that capture both broad identity features and fine-grained identity features to support different generative tasks.

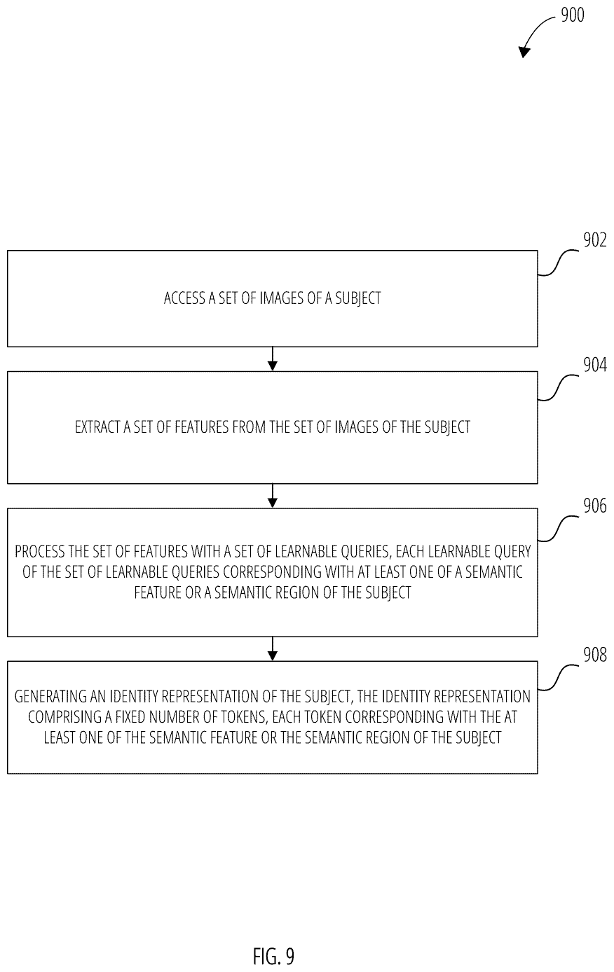

FIG. 9 illustrates an example method 900, according to some examples. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

At operation 902, the example method 900 accesses a set of images of a subject. The set of images may be accessed, for example, based on the encoder described with respect to FIGS. 5-8. At operation 904, the example method 900 extracts a set of features from the set of images of the subject. The set of features may be extracted, for example, based on the encoder described with respect to FIG. 6. At operation 906, the example method 900 processes the set of features with a set of learnable queries, each learnable query of the set of learnable queries corresponding with at least one of a semantic feature or a semantic region of the subject. The set of features may be processed, for example, based on the encoder described with respect to FIGS. 5-8. At operation 908, the example method 900 generates an identity representation of the subject, the identity representation comprising a set of tokens, each token of the set of tokens corresponding with the at least one of the semantic feature or the semantic region of the subject. The identity representation may be generated, for example, based on the encoder described with respect to FIGS. 5-8.

### Data Architecture

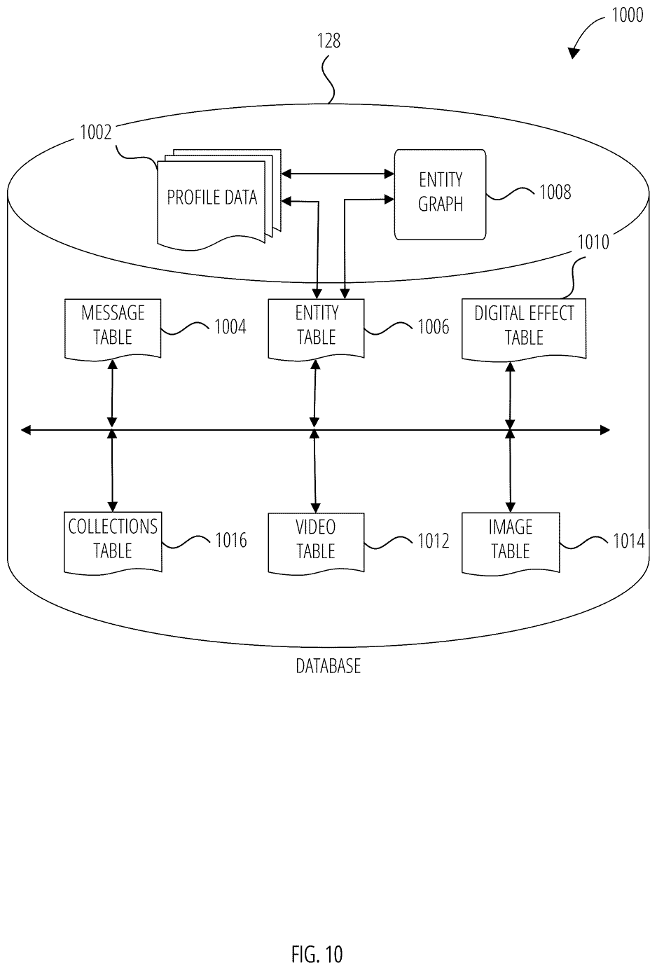

FIG. 10 is a schematic diagram illustrating data structures 1000, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 1004. This message data includes at least message sender data, message recipient (or receiver) data, and a payload. Further details regarding information that may be included in a message, and included within the message data stored in the message table 1004, are described below with reference to FIG. 10.

An entity table 1006 stores entity data, and is linked (e.g., referentially) to an entity graph 1008 and profile data 1002. Entities for which records are maintained within the entity table 1006 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 1008 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 1006. Such privacy settings may be applied to all types of relationships within the context of the digital interaction system 100, or may selectively be applied to certain types of relationships.

The profile data 1002 stores multiple types of profile data about a particular entity. The profile data 1002 may be selectively used and presented to other users of the digital interaction system 100 based on privacy settings specified by a particular entity. Where the entity is an individual, the profile data 1002 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 1002 for the group may similarly include one or more avatar representations associated with the group, in addition to the group name, members, and various settings (e.g., notifications) for the relevant group.

The database 128 also stores digital effect data, such as overlays or filters, in a digital effect table 1010. The digital effect data is associated with and applied to videos (for which data is stored in a video table 1012) and images (for which data is stored in an image table 1014).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data that may be stored within the image table 1014 includes augmented reality content items (e.g., corresponding to augmented reality experiences). An augmented reality content item may be a real-time special effect and sound that may be added to an image or a video.

A collections table 1016 stores data regarding collections of messages and associated image, video, or audio data, which are compiled into a collection (e.g., a narrative or a gallery). The creation of a particular collection may be initiated by a particular user (e.g., each user for which a record is maintained in the entity table 1006). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 1012 stores video data that, in some examples, is associated with messages for which records are maintained within the message table 1004. Similarly, the image table 1014 stores image data associated with messages for which message data is stored in the entity table 1006. The entity table 1006 may associate various digital effects from the digital effect table 1010 with various images and videos stored in the image table 1014 and the video table 1012.

### Data Communications Architecture

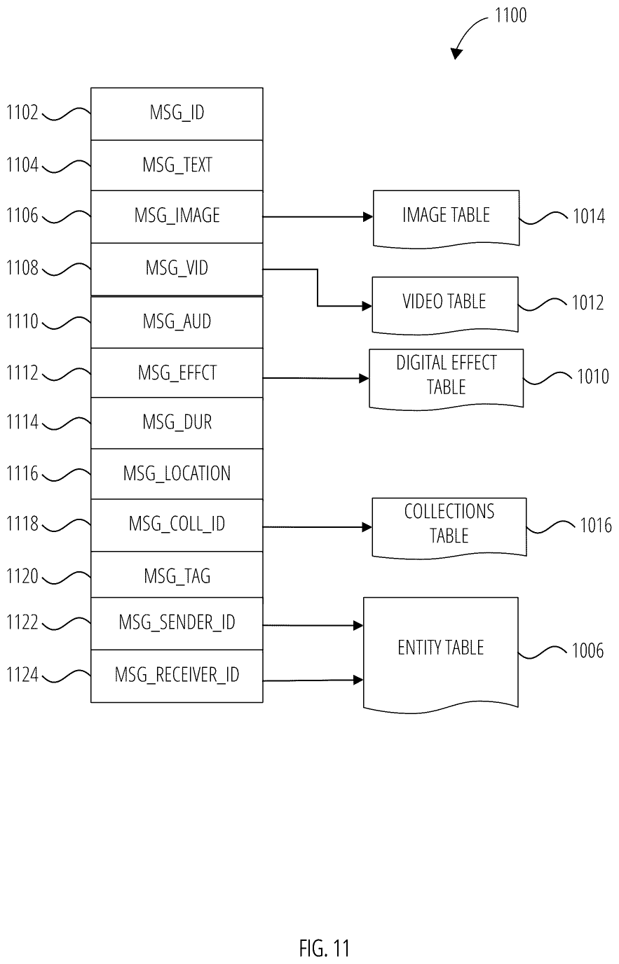

FIG. 11 is a schematic diagram illustrating a structure of a message 1100, according to some examples, generated by an interaction client 104 for communication to a further interaction client 104 via the servers 124. The content of a particular message 1100 is used to populate the message table 1004 stored within the database 128, accessible by the servers 124. Similarly, the content of a message 1100 is stored in memory as “in-transit” or “in-flight” data of the user system 102 or the servers 124. A message 1100 is shown to include the following example components:
Message identifier 1102: a unique identifier that identifies the message 1100.
Message text payload 1104: text, to be generated by a user via a user interface of the user system 102, and that is included in the message 1100.
Message image payload 1106: image data, captured by a camera component of a user system 102 or retrieved from a memory component of a user system 102, and that is included in the message 1100. Image data for a sent or received message 1100 may be stored in the image table 1014.
Message video payload 1108: video data, captured by a camera component or retrieved from a memory component of the user system 102, and that is included in the message 1100. Video data for a sent or received message 1100 may be stored in the video table 1012.
Message audio payload 1110: audio data, captured by a microphone or retrieved from a memory component of the user system 102, and that is included in the message 1100.
Message digital effect data 1112: digital effect data (e.g., filters, stickers, or other annotations or enhancements) that represents digital effects to be applied to message image payload 1106, message video payload 1108, or message audio payload 1110 of the message 1100. Digital effect data for a sent or received message 1100 may be stored in the digital effect table 1010.
Message duration parameter 1114: parameter value indicating, in seconds, the amount of time for which content of the message (e.g., the message image payload 1106, message video payload 1108, message audio payload 1110) is to be presented or made accessible to a user via the interaction client 104.
Message geolocation parameter 1116: geolocation data (e.g., latitudinal, and longitudinal coordinates) associated with the content payload of the message. Multiple message geolocation parameter 1116 values may be included in the payload, each of these parameter values being associated with respect to content items included in the content (e.g., a specific image within the message image payload 1106, or a specific video in the message video payload 1108).
Message collection identifier 1118: identifier values identifying one or more content collections (e.g., “stories” identified in the collections table 1016) with which a particular content item in the message image payload 1106 of the message 1100 is associated. For example, multiple images within the message image payload 1106 may each be associated with multiple content collections using identifier values.
Message tag 1120: each message 1100 may be tagged with multiple tags, each of which is indicative of the subject matter of content included in the message payload. For example, where a particular image included in the message image payload 1106 depicts an animal (e.g., a lion), a tag value may be included within the message tag 1120 that is indicative of the relevant animal. Tag values may be generated manually, based on user input, or may be automatically generated using, for example, image recognition.
Message sender identifier 1122: an identifier (e.g., a messaging system identifier, email address, or device identifier) indicative of a user of the user system 102 on which the message 1100 was generated and from which the message 1100 was sent.
Message receiver identifier 1124: an identifier (e.g., a messaging system identifier, email address, or device identifier) indicative of a user of the user system 102 to which the message 1100 is addressed.

The contents (e.g., values) of the various components of message 1100 may be pointers to locations in tables within which content data values are stored. For example, an image value in the message image payload 1106 may be a pointer to (or address of) a location within an image table 1014. Similarly, values within the message video payload 1108 may point to data stored within a video table 1012, values stored within the message digital effect data 1112 may point to data stored in a digital effect table 1010, values stored within the message collection identifier 1118 may point to data stored in a collections table 1016, and values stored within the message sender identifier 1122 and the message receiver identifier 1124 may point to user records stored within an entity table 1006.

### Machine Architecture

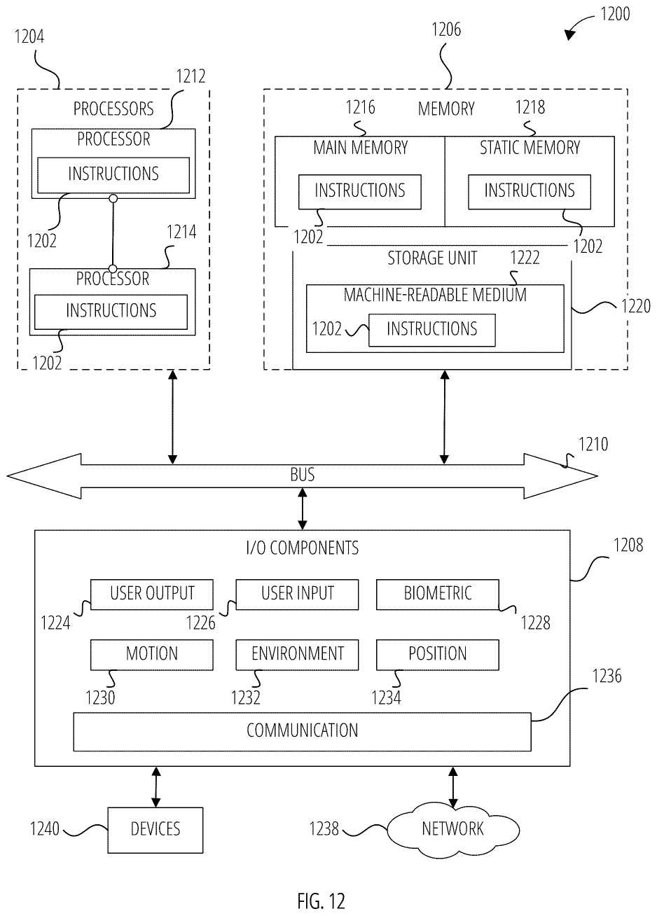

FIG. 12 is a diagrammatic representation of the machine 1200 within which instructions 1202 (e.g., software, a program, an application, an applet, an app, or other executable code) for causing the machine 1200 to perform any one or more of the methodologies discussed herein may be executed. For example, the instructions 1202 may cause the machine 1200 to execute any one or more of the methods described herein. The instructions 1202 transform the general, non-programmed machine 1200 into a particular machine 1200 programmed to carry out the described and illustrated functions in the manner described. The machine 1200 may operate as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1202, sequentially or otherwise, that specify actions to be taken by the machine 1200. Further, while a single machine 1200 is illustrated, the term “machine” shall also be taken to include a collection of machines that individually or jointly execute the instructions 1202 to perform any one or more of the methodologies discussed herein. The machine 1200, for example, may comprise the user system 102 or any one of multiple server devices forming part of the server system 110. In some examples, the machine 1200 may also comprise both client and server systems, with certain operations of a particular method or algorithm being performed on the server-side and with certain operations of the method or algorithm being performed on the client-side.

The machine 1200 may include Processors 1204, memory 1206, and input/output I/O components 1208, which may be configured to communicate with each other via a bus 1210.

The memory 1206 includes a main memory 1216, a static memory 1218, and a storage unit 1220, both accessible to the Processors 1204 via the bus 1210. The main memory 1206, the static memory 1218, and storage unit 1220 store the instructions 1202 embodying any one or more of the methodologies or functions described herein. The instructions 1202 may also reside, completely or partially, within the main memory 1216, within the static memory 1218, within machine-readable medium 1222 within the storage unit 1220, within at least one of the Processors 1204 (e.g., within the processor's cache memory), or any suitable combination thereof, during execution thereof by the machine 1200.

The I/O components 1208 may include a wide variety of components to receive input, provide output, produce output, transmit information, exchange information, capture measurements, and so on. The specific I/O components 1208 that are included in a particular machine will depend on the type of machine. For example, portable machines such as mobile phones may include a touch input device or other such input mechanisms, while a headless server machine will likely not include such a touch input device. It will be appreciated that the I/O components 1208 may include many other components that are not shown in FIG. 12. In various examples, the I/O components 1208 may include user output components 1224 and user input components 1226. The user output components 1224 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1226 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1208 may include biometric components 1228, motion components 1230, environmental components 1232, or position components 1234, among a wide array of other components. For example, the biometric components 1228 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1230 include acceleration sensor components (e.g., accelerometer), gravitation sensor components, rotation sensor components (e.g., gyroscope).

The environmental components 1232 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which might consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1208 further include communication components 1236 operable to couple the machine 1200 to a Network 1238 or devices 1240 via respective coupling or connections. For example, the communication components 1236 may include a network interface component or another suitable device to interface with the Network 1238. In further examples, the communication components 1236 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1240 may be another machine or any of a wide variety of peripheral devices (e.g., a peripheral device coupled via a USB).

Moreover, the communication components 1236 may detect identifiers or include components operable to detect identifiers. For example, the communication components 1236 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1236, such as location via Internet Protocol (IP) geolocation, location via Wi-Fi® signal triangulation, location via detecting an NFC beacon signal that may indicate a particular location, and so forth.

The various memories (e.g., main memory 1216, static memory 1218, and memory of the Processors 1204) and storage unit 1220 may store one or more sets of instructions and data structures (e.g., software) embodying or used by any one or more of the methodologies or functions described herein. These instructions (e.g., the instructions 1202), when executed by Processors 1204, cause various operations to implement the disclosed examples.

The instructions 1202 may be transmitted or received over the Network 1238, using a transmission medium, via a network interface device (e.g., a network interface component included in the communication components 1236) and using any one of several well-known transfer protocols (e.g., hypertext transfer protocol (HTTP)). Similarly, the instructions 1202 may be transmitted or received using a transmission medium via a coupling (e.g., a peer-to-peer coupling) to the devices 1240.

### Software Architecture

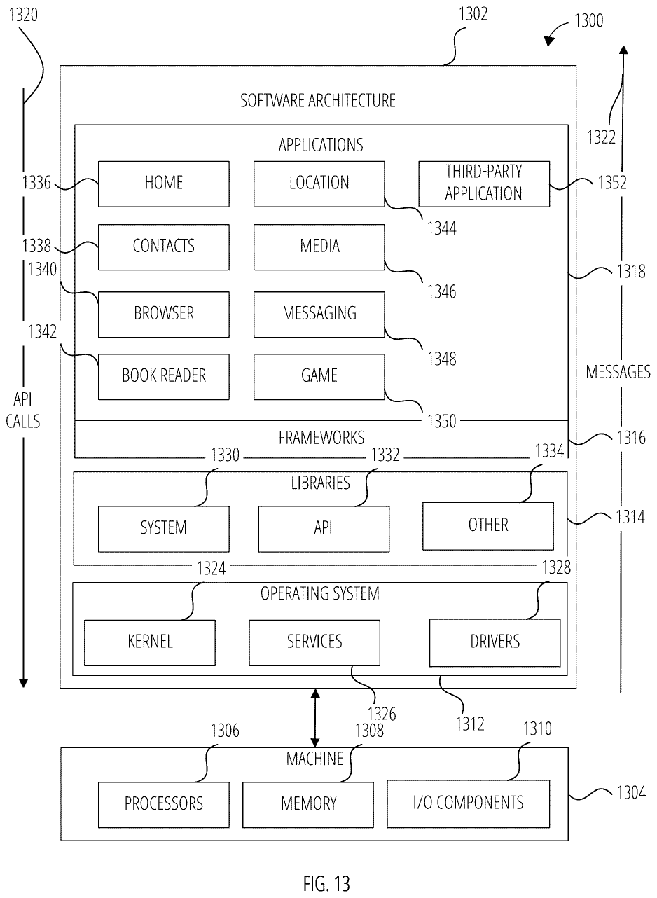

FIG. 13 is a block diagram 1300 illustrating a software architecture 1302, which can be installed on any one or more of the devices described herein. The software architecture 1302 is supported by hardware such as a machine 1304 that includes Processors 1306, memory 1308, and I/O components 1310. In this example, the software architecture 1302 can be conceptualized as a stack of layers, where each layer provides a particular functionality. The software architecture 1302 includes layers such as an operating system 1312, libraries 1314, frameworks 1316, and applications 1318. Operationally, the applications 1318 invoke API calls 1320 through the software stack and receive messages 1322 in response to the API calls 1320.

The operating system 1312 manages hardware resources and provides common services. The operating system 1312 includes, for example, a kernel 1324, services 1326, and drivers 1328. The kernel 1324 acts as an abstraction layer between the hardware and the other software layers. For example, the kernel 1324 provides memory management, processor management (e.g., scheduling), component management, networking, and security settings, among other functionalities. The services 1326 can provide other common services for the other software layers. The drivers 1328 are responsible for controlling or interfacing with the underlying hardware. For instance, the drivers 1328 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1314 provide a common low-level infrastructure used by the applications 1318. The libraries 1314 can include system libraries 1330 (e.g., C standard library) that provide functions such as memory allocation functions, string manipulation functions, mathematical functions, and the like. In addition, the libraries 1314 can include API libraries 1332 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1314 can also include a wide variety of other libraries 1334 to provide many other APIs to the applications 1318.

The frameworks 1316 provide a common high-level infrastructure that is used by the applications 1318. For example, the frameworks 1316 provide various graphical user interface (GUI) functions, high-level resource management, and high-level location services. The frameworks 1316 can provide a broad spectrum of other APIs that can be used by the applications 1318, some of which may be specific to a particular operating system or platform.

In an example, the applications 1318 may include a home application 1336, a contacts application 1338, a browser application 1340, a book reader application 1342, a location application 1344, a media application 1346, a messaging application 1348, a game application 1350, and a broad assortment of other applications such as a third-party application 1352. The applications 1318 are programs that execute functions defined in the programs. Various programming languages can be employed to create one or more of the applications 1318, structured in a variety of manners, such as object-oriented programming languages (e.g., Objective-C, Java, or C++) or procedural programming languages (e.g., C or assembly language). In a specific example, the third-party application 1352 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1352 can invoke the API calls 1320 provided by the operating system 1312 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number, respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Example Statements

Example 1 is a system comprising: one or more processors; and memory storing instructions that, when executed by the one or more processors, cause the system to perform operations comprising: accessing a set of images of a subject; extracting a set of features from the set of images of the subject; processing the set of features with a set of learnable queries, each learnable query of the set of learnable queries corresponding with at least one of a semantic feature or a semantic region of the subject; and generating an identity representation of the subject, the identity representation comprising a set of tokens, each token of the set of tokens corresponding with the at least one of the semantic feature or the semantic region of the subject.

In Example 2, the subject matter of Example 1 comprises training an encoder to generate the identity representation, the training comprising: selecting a first subset of training images from a set of training images; selecting a second subset of training images from the set of training images; generating a training identity representation based on the first subset of training images using the encoder; generating a plurality of sets of output images using a plurality of decoders based on the training identity representation and the second subset of training images; and minimizing a loss function between the plurality of sets of output images and the second subset of training images.

In Example 3, the subject matter of Example 2 comprises wherein generating the plurality of sets of output images comprises: applying a mask to the second subset of training images, wherein a set of output images of the plurality of sets of output images are generated based on the masked second subset of training images.

In Example 4, the subject matter of Examples 2-3 comprises wherein generating the plurality of sets of output images comprises: applying noise to the second subset of training images to generate a noisy second subset of training images, wherein a set of output images of the plurality of sets of output images are generated based on the noisy second subset of training images.

In Example 5, the subject matter of Examples 1-4 comprises wherein extracting the set of features comprises: extracting a set of visual features from the set of images; identifying shared visual features in the set of visual features that are shared in a plurality of images in the set of images; and combining the shared visual features.

In Example 6, the subject matter of Examples 1-5 comprises wherein processing the set of features comprises: providing a set of query components, a set of key components, and a set of value components, the set of query components corresponding with the set of learnable queries, the set of key components and the set of value components corresponding with the set of features.

In Example 7, the subject matter of Examples 1-6 comprises wherein processing the set of features comprises: combining first information related to a first feature of the set of features that is missing or occluded in a first image of the set of images with second information related to the first feature that is depicted in a second image of the set of images.

In Example 8, the subject matter of Examples 1-7 comprises wherein processing the set of features comprises: combining first information related to a first feature of the set of features that is depicted in a first pose in a first image of the set of images with second information related to the first feature that is depicted in a second pose in a second image of the set of images.

In Example 9, the subject matter of Examples 1-8 comprises capturing a video of the subject; and obtaining the set of images by sampling the video, each image of the set of images depicting the subject in a different pose.

In Example 10, the subject matter of Example 9 comprises wherein the tokens of the identity representation further correspond with at least one of identity preserving features of a person or identity preserving regions of the person.

Example 11 is a method comprising: accessing a set of images of a subject; extracting a set of features from the set of images of the subject processing the set of features with a set of learnable queries, each learnable query of the set of learnable queries corresponding with at least one of a semantic feature or a semantic region of the subject; and generating an identity representation of the subject, the identity representation comprising a set of tokens, each token of the set of tokens corresponding with the at least one of the semantic feature or the semantic region of the subject.

In Example 12, the subject matter of Example 11 training an encoder to generate the identity representation, the training comprising: selecting a first subset of training images from a set of training images; selecting a second subset of training images from the set of training images; generating a training identity representation based on the first subset of training images using the encoder; generating a plurality of sets of output images using a plurality of decoders based on the training identity representation and the second subset of training images; and minimizing a loss function between the plurality of sets of output images and the second subset of training images.

In Example 13, the subject matter of Example 12 comprises wherein generating the plurality of sets of output images comprises: applying a mask to the second subset of training images, wherein a set of output images of the plurality of sets of output images are generated based on the masked second subset of training images.

In Example 14, the subject matter of Examples 12-13 comprises wherein generating the plurality of sets of output images comprises: applying noise to the second subset of training images to generate a noisy second subset of training images, wherein a set of output images of the plurality of sets of output images are generated based on the noisy second subset of training images.

In Example 15, the subject matter of Example 11-14 comprises wherein extracting the set of features comprises: extracting a set of visual features from the set of images; identifying shared visual features in the set of visual features that are shared in a plurality of images in the set of images; and combining the shared visual features.

In Example 16, the subject matter of Examples 11-15 comprises wherein processing the set of features comprises: providing a set of query components, a set of key components, and a set of value components, the set of query components corresponding with the set of learnable queries, the set of key components and the set of value components corresponding with the set of features.

In Example 17, the subject matter of Examples 11-16 comprises wherein processing the set of features comprises: combining first information related to a first feature of the set of features that is missing or occluded in a first image of the set of images with second information related to the first feature that is depicted in a second image of the set of images.

In Example 18, the subject matter of Examples 11-17 comprises wherein processing the set of features comprises: combining first information related to a first feature of the set of features that is depicted in a first pose in a first image of the set of images with second information related to the first feature that is depicted in a second pose in a second image of the set of images.

In Example 19, the subject matter of Examples 11-18 comprises capturing a video of the subject; and obtaining the set of images by sampling the video, each image of the set of images depicting the subject in a different pose.

Example 20 is a non-transitory computer-readable storage medium storing instructions that, when executed by at least one processor, cause the at least one processor to perform operations comprising: accessing a set of images of a subject; extracting a set of features from the set of images of the subject; processing the set of features with a set of learnable queries, each learnable query of the set of learnable queries corresponding with at least one of a semantic feature or a semantic region of the subject; and generating an identity representation of the subject, the identity representation comprising a set of tokens, each token of the set of tokens corresponding with the at least one of the semantic feature or the semantic region of the subject.

Example 21 is an apparatus or a device comprising means to implement of any of Examples 1-20.

### Term Examples

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VOIP) network, a cellular telephone network, a 5GTM network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled, or owned by a user and with which the user interacts perform an action, engagement, or interaction on the user device, including an interaction with other users or computer systems.

What is claimed is:

1. A system comprising:
one or more processors; and
memory storing instructions that, when executed by the one or more processors, cause the system to perform operations comprising:
accessing a set of images of a subject;
extracting a set of features from the set of images of the subject;
processing the set of features with a set of learnable queries, each learnable query of the set of learnable queries corresponding with at least one of a semantic feature or a semantic region of the subject; and
generating an identity representation of the subject, the identity representation comprising a set of tokens, each token of the set of tokens corresponding with the at least one of the semantic feature or the semantic region of the subject.

2. The system of claim 1, the operations further comprising:
training an encoder to generate the identity representation, the training comprising:
selecting a first subset of training images from a set of training images;
selecting a second subset of training images from the set of training images;
generating a training identity representation based on the first subset of training images using the encoder;
generating a plurality of sets of output images using a plurality of decoders based on the training identity representation and the second subset of training images; and
minimizing a loss function between the plurality of sets of output images and the second subset of training images.

3. The system of claim 2, wherein generating the plurality of sets of output images comprises:
applying a mask to the second subset of training images, wherein a set of output images of the plurality of sets of output images are generated based on the masked second subset of training images.

4. The system of claim 2, wherein generating the plurality of sets of output images comprises:
applying noise to the second subset of training images to generate a noisy second subset of training images, wherein a set of output images of the plurality of sets of output images are generated based on the noisy second subset of training images.

5. The system of claim 1, wherein extracting the set of features comprises:
extracting a set of visual features from the set of images;
identifying shared visual features in the set of visual features that are shared in a plurality of images in the set of images; and
combining the shared visual features.

6. The system of claim 1, wherein processing the set of features comprises:
providing a set of query components, a set of key components, and a set of value components, the set of query components corresponding with the set of learnable queries, the set of key components and the set of value components corresponding with the set of features.

7. The system of claim 1, wherein processing the set of features comprises:
combining first information related to a first feature of the set of features that is missing or occluded in a first image of the set of images with second information related to the first feature that is depicted in a second image of the set of images.

8. The system of claim 1, wherein processing the set of features comprises:
combining first information related to a first feature of the set of features that is depicted in a first pose in a first image of the set of images with second information related to the first feature that is depicted in a second pose in a second image of the set of images.

9. The system of claim 1, the operations further comprising:
capturing a video of the subject; and
obtaining the set of images by sampling the video, each image of the set of images depicting the subject in a different pose.

10. The system of claim 1, wherein the tokens of the identity representation further correspond with at least one of identity preserving features of a person or identity preserving regions of the person.

11. A method comprising:
accessing a set of images of a subject;
extracting a set of features from the set of images of the subject;
processing the set of features with a set of learnable queries, each learnable query of the set of learnable queries corresponding with at least one of a semantic feature or a semantic region of the subject; and
generating an identity representation of the subject, the identity representation comprising a set of tokens, each token of the set of tokens corresponding with the at least one of the semantic feature or the semantic region of the subject.

12. The method of claim 11, further comprising:
training an encoder to generate the identity representation, the training comprising:
selecting a first subset of training images from a set of training images;
selecting a second subset of training images from the set of training images;
generating a training identity representation based on the first subset of training images using the encoder;
generating a plurality of sets of output images using a plurality of decoders based on the training identity representation and the second subset of training images; and
minimizing a loss function between the plurality of sets of output images and the second subset of training images.

13. The method of claim 12, wherein generating the plurality of sets of output images comprises:
applying a mask to the second subset of training images, wherein a set of output images of the plurality of sets of output images are generated based on the masked second subset of training images.

14. The method of claim 12, wherein generating the plurality of sets of output images comprises:
applying noise to the second subset of training images to generate a noisy second subset of training images, wherein a set of output images of the plurality of sets of output images are generated based on the noisy second subset of training images.

15. The method of claim 11, wherein extracting the set of features comprises:
extracting a set of visual features from the set of images;
identifying shared visual features in the set of visual features that are shared in a plurality of images in the set of images; and
combining the shared visual features.

16. The method of claim 11, wherein processing the set of features comprises:
providing a set of query components, a set of key components, and a set of value components, the set of query components corresponding with the set of learnable queries, the set of key components and the set of value components corresponding with the set of features.

17. The method of claim 11, wherein processing the set of features comprises:
combining first information related to a first feature of the set of features that is missing or occluded in a first image of the set of images with second information related to the first feature that is depicted in a second image of the set of images.

18. The method of claim 11, wherein processing the set of features comprises:
combining first information related to a first feature of the set of features that is depicted in a first pose in a first image of the set of images with second information related to the first feature that is depicted in a second pose in a second image of the set of images.

19. The method of claim 11, further comprising:
capturing a video of the subject; and
obtaining the set of images by sampling the video, each image of the set of images depicting the subject in a different pose.

20. A non-transitory computer-readable storage medium storing instructions that, when executed by at least one processor, cause the at least one processor to perform operations comprising:
accessing a set of images of a subject;
extracting a set of features from the set of images of the subject;
processing the set of features with a set of learnable queries, each learnable query of the set of learnable queries corresponding with at least one of a semantic feature or a semantic region of the subject; and
generating an identity representation of the subject, the identity representation comprising a set of tokens, each token of the set of tokens corresponding with the at least one of the semantic feature or the semantic region of the subject.
